(19) United States
(12) Patent Application Publication
(10) Pub. No.: US 2008/0294632 A1
(43) Pub. Date: Nov. 27, 2008

(54) Method and System for Sorting/Searching File and Record Media Therefor

(75) Inventors: Joon-Kee Chang, Gyeonggi-do (KR); Soon-Sik So, Seoul (KR); Mi-Yeon Kim, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/158,235

(22) PCT Filed: Dec. 20, 2006
(86) PCT No.: PCT/KR2006/005606

§ 371 Date: Jun. 19, 2008

(30) Foreign Application Priority Data
Dec. 20, 2005 (KR) 10-2005-0126407

(51) Int. Cl. G06F 7/00; G06F 17/30

(52) U.S. Cl. 707/5; 707/102; 707/3; 707/E17.014

(57) ABSTRACT

A method, a system and a recorded medium for sorting and searching files are disclosed. A method of sorting and searching files have the steps of (a) outputting an annotation interface for an original file selected by a user, (b) receiving annotation details inputted through the annotation interface, (c) generating an annotation file in accordance with the annotation details, and (d) storing the annotation file. With the present invention, the efficient sorting and searching of files can be easily performed by using all kinds of fields stored in a user terminal.

### TECHNICAL FIELD

The present invention relates to a method, a system and a recorded medium for sorting and searching a file, more specifically to a method, a system and a recorded medium for effectively sorting and searching a file by using an annotation.

### BACKGROUND ART

A lot of information is pouring into our lives as being deserved to be called the flood of information.

For example, twenty hundred new books are in print and approximately 540 million giga-byte information is generated per day. When a key word of “PDA” is entered in the Google site, for example, 74.3 million sites are searched within one second. Indeed, information is exploding, and better methods for searching the information continue to be introduced.

In the past, people mainly depended on books and newspapers to obtain desired information. However, we have been recently able to easily access desired information through the Internet without the restriction of time and location thanks to the all-pervasive use of computer, the improvement of processing speed and the development of network transmission technology.

Almost all of our works are done with the computer, and the works, such as text documents, meeting data and image, are generally stored in file formats in the computer.

As such, along with the excessive production of information, a user stores a lot of data in the computer. Accordingly, sorting and classifying the stored data, instead of searching and obtaining desired information, is increasingly becoming a new issue.

A typical desk top personal computer (PC) supports a data searching function. However, since the present data searching is processed with folder names or file names only, in case that a user does not remember the folder name or file name, the user cannot find the desired folder or file.

To solve the above problem, recent servers, connected to a user PC by a network, support the data searching function to allow any text searched in files that are stored in the PC. Accordingly, although the user does not know the name of the desired folder or file, the user can find the folder or file.

However, this user PC searching function can not add particular information for classifying binary files (e.g. image) or add the classification for sorting HTML files. The user PC searching function can carry out the searching only based on the information of object files. The user PC searching function has not been able to support the classification and sorting of the object files.

These days, services for sorting and searching information adequately and promptly has become more important than providing a large amount of information. The conventional art, however, has not been able to provide this kind of service.

### DISCLOSURE

### Technical Problem

The present invention, to solve the problem of the above-described conventional art, provides a method and a system and a recorded medium for sorting and searching a file that can efficiently sort various kinds of files stored in a user terminal.

The present invention also provides a method, a system and a recorded medium for sorting and searching a file that can define detailed searching conditions of an original file stored in the user terminal.

Further, the present invention provides a method, a system and a recorded medium for sorting and searching a file that can efficiently search the original file.

Other objects of the present invention will become more apparent through the embodiments described below.

### Technical Solution

To achieve the above objects, according to an embodiment of the present invention, there is provided a method of sorting and searching files including the steps of (a) outputting an annotation interface for an original file selected by a user; (b) receiving annotation details inputted through the annotation interface, the annotation details comprising at least one selected from the group consisting of a title, a subject, a category, an importance, a keyword and a description of the original file; (c) generating an annotation file in accordance with the annotation details, the annotation file comprising a header information field having at least one of a name of the original file and a date of generating the annotation file and a body information field corresponding to annotation details inputted by the user; and (d) storing the annotation file.

In accordance with the present invention, the annotation file is preferably defined with an extensible markup language (XML), and the name of the annotation file preferably has a name of the original file.

Also, the body information field can include an image information field having at least one of a photographed place, a photographed person, a photographed object and a photographing camera of an image file.

In the method in accordance with the present invention, the annotation file is preferably matched to the original file and stored.

Also, the method in accordance with the present invention further has the steps of receiving a search keyword inputted by a user; searching a first file, stored as data corresponding to the search keyword in a storage medium; searching a second file matched to the searched first file; and outputting a combination of the first file and the second file as a search result, whereas the first file is any one of the original file and the annotation file, and the second file is the other of the original file and the annotation file

Also, the method preferably further has indexing the generated annotation file when the annotation file is generated; and synchronizing the searched annotation file with the original file.

Preferably, the steps of (a) through (d) can be performed by a web server that is connected to a user terminal through a network, and the original file can be a web file created by a user on the web.

Also, the original file can be stored in the user terminal.

According to another embodiment of the present invention, there is provided a recorded medium having recorded a program for executing the method, whereas the recorded medium is readable by a computer.

According to another embodiment of the present invention, there is provided a method of sorting and searching files including (a) receiving a search keyword inputted by a user; (b) searching a first file stored as data corresponding to the search keyword in a storage medium; (c) searching a second file matched to the searched first file; and (d) outputting a combination of the first file and the second file as a search result.

According to another embodiment of the present invention, there is provided a web server system being connected to a user terminal through a network and supporting sorting and searching files, which includes a webpage providing module, sending a webpage for creating annotation details to the user terminal; an annotation details receiving module, receiving annotation details from the user terminal, the annotation details comprising at least one of a title, a subject, a category, an importance, a keyword and a description of the original file; an annotation file generating module, generating an annotation file in accordance with the annotation details, the annotation file comprising a header information field having at least one of a name of the original file and a date of generating the annotation file and a body information field corresponding to the annotation details inputted by the user; and an annotation file storing module, matching the annotation file to the original file and storing the annotation file.

### DESCRIPTION OF DRAWING

FIG. 1 illustrates a structure of a system in accordance with an embodiment of the present invention;

FIG. 2 illustrates a module structure of an annotation application in accordance with a first embodiment of the present invention;

FIG. 3 illustrates a field structure of an annotation file in accordance with the present invention;

FIG. 4 illustrates a module structure of a desktop searching application in accordance with a first embodiment of the present invention;

FIG. 5 is a flow chart illustrating a process of generating an annotation file in accordance with a first embodiment of the present invention;

FIG. 6 is a flow chart illustrating a process of editing an annotation file in accordance with a first embodiment of the present invention;

FIG. 7 is a flow chart illustrating a process of searching a file by linking a desktop searching application in accordance with the present invention;

FIG. 8 illustrates an example of a screen of an annotation interface in accordance with a first embodiment of the present invention;

FIG. 9 illustrates an example of a screen of outputting an original file according to a time line in accordance with a first embodiment of the present invention;

FIG. 10 illustrates an example of a screen of a case of searching a file by linking a desktop searching application of the present invention;

FIG. 11 illustrates a module structure of a web server in accordance with a second embodiment of the present invention; and

FIG. 12 is a flow chart illustrating a process of generating an annotation file in accordance with a second embodiment of the present invention.

### MODE FOR INVENTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

A few embodiments of the method, system and recorded medium for sorting and searching a file in accordance with the present invention will be hereinafter described in detail with reference to the accompanying drawings.

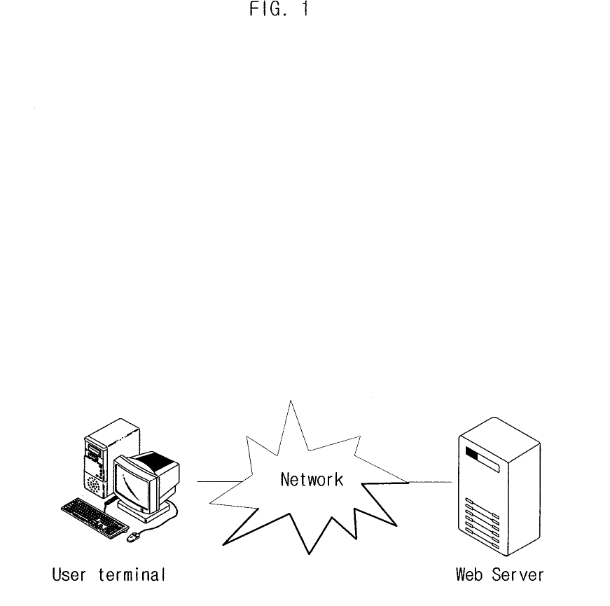

FIG. 1 illustrates the structure of a system in accordance with a first embodiment of the present invention.

A system for sorting and searching a file stored in a user terminal is illustrated in FIG. 1. The system in accordance with the present invention can include a web server 102 and be connected to the user terminal 100 through a network.

The network can include a wire network, such as the Internet and a leased line, and a wireless network, such as the wireless Internet, a mobile communication network and a satellite communication network.

The user terminal 100, which is accessible to the network, is equipped with an application for sorting and searching files, and can include a desktop PC, a laptop PC, a PDA and a typical mobile communication terminal.

In accordance with a first embodiment of the present invention, the web server 102 provides an application for sorting and searching files to the user terminal 100. The application allows a user to make an annotation for all kinds of files stored in the user terminal. This application will be referred to as an annotation application, hereinafter.

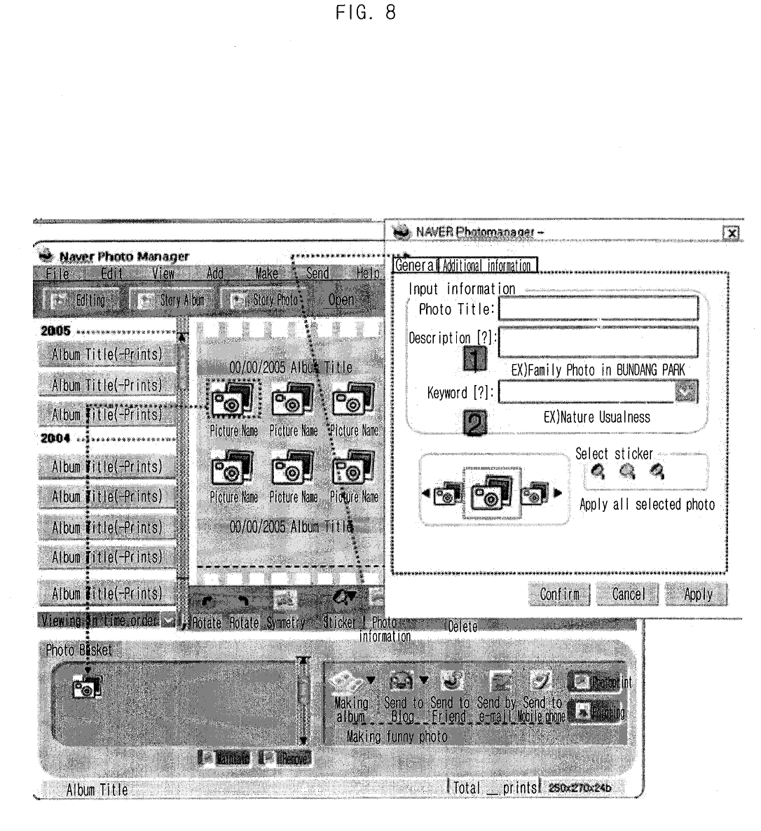

The annotation application is installed in the user terminal. In case that the user selects one of the original files and desires to make an annotation for the file, as illustrated in FIG. 8, an interface for inputting detailed information of the annotation is outputted.

The annotation interface in accordance with the present invention has fields where various annotation details can be inputted. There are fields for inputting, for example, the title, subject, category, keyword and brief note of the original file. Also, the annotation interface has another field for selecting an icon (e.g. a color sticker) to show the importance of the original file.

In case that the original file is an image file, the annotation application additionally outputs a field for inputting detailed information on the image, such as a photographed place, a photographed person, a photographed object, photographing feeling and details related to a photographing camera, for example.

If the user inputs at least one of the above-mentioned annotation details, the annotation application generates an annotation file and stores the annotation file by matching the annotation file to the original file.

The annotation file in accordance with the present invention is defined with an extensible markup language (XML), and therefore the structure can be easily changed by the user.

As such, in case that the annotation file for the original file is generated, the user later can not only check the original file and the corresponding annotation file through an annotation interface but also search the original file by using the annotation details.

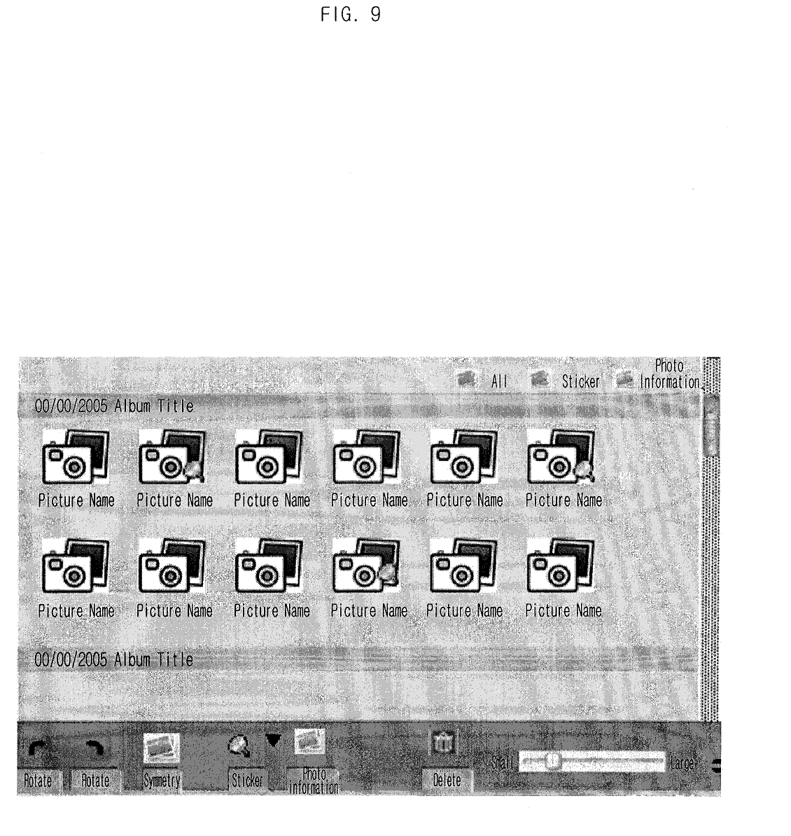

In accordance with the present invention, the annotation application can display the original file in a directory style or a time line style (per stored date of the original file), as shown in FIG. 9.

The user can check the annotation details of the original file, and edit or delete the annotation details through the annotation interface.

In accordance with an embodiment of the present invention, by linking the desktop searching application, the user can search the original file and the annotation file and edit the annotation file.

The desktop searching application is used to search the files stored in the user terminal 100 on a web browser and output the search result in a webpage style for the user's checking.

In accordance with the present invention, in case that the user inputs a search keyword, the desktop searching application searches a first file, stored in storage means, corresponding to the search keyword. The first file can be at least one of the original file and the annotation files, generated according to the annotation details that the user has inputted for the original file.

Then, the desktop searching application searches a second file matched to the searched first file and outputs the combination of the first file and the second file as the search result.

As described above, since the original file and the annotation file in accordance with the present invention are matched to each other and stored, in case that the searched first file is the original file, the second file is the corresponding matched annotation file, and in case that the first file is the annotation file, the second file is the corresponding matched original file.

Accordingly, although the search keyword is included in the annotation file as well as the original file, the desktop searching application can provide the search result.

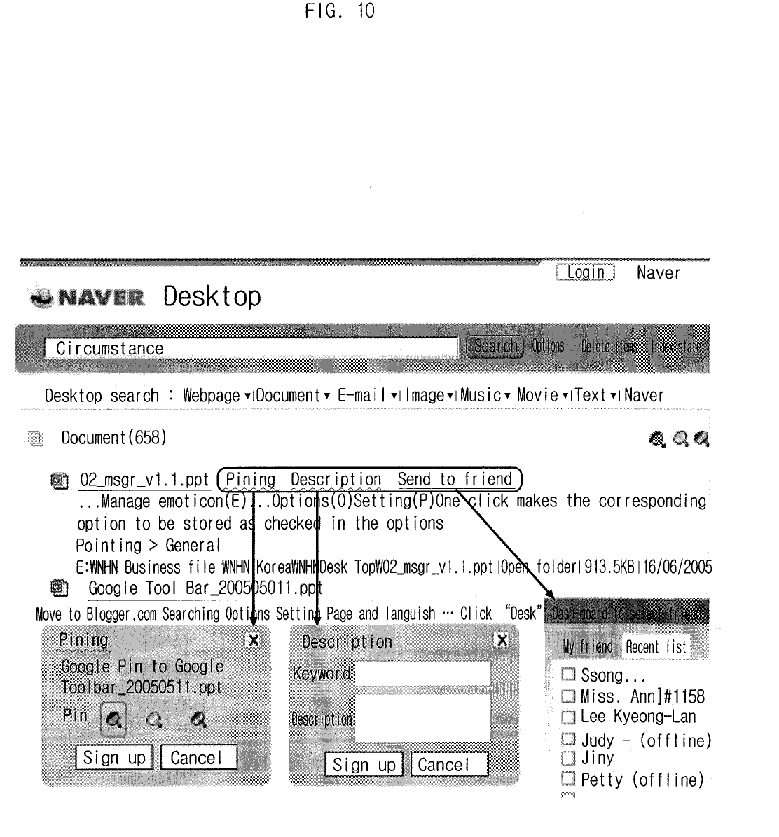

In detail, as shown in FIG. 10, in case that the user inputs a search keyword into a search window of the web browser, the desktop searching application receives the inputted search keyword and searches the original file and the annotation file, corresponding to the search keyword.

The desktop searching application of the present invention recognizes the generation of the annotation file and performs an indexing operation for the annotation file. Through this indexing operation, the annotation file can be efficiently searched.

If there is an original file or annotation file corresponding to the search keyword, the desktop searching application synchronizes the annotation file and the original file and outputs a search result page on the web browser. At this time, the combination of the original file and annotation file is outputted.

Accordingly, similar to browsing a webpage, the user can search the original file or the annotation file, stored in the user terminal, and check the annotation details on the original file.

The search result page includes an annotation editing interface. The user, as illustrated in FIG. 10, can easily edit the annotation details in the search result page.

Hitherto, it has been described that the desktop searching application outputs the webpage style of search result, but this is merely an example. Alternatively, it is possible that an XML format of search result information is transmitted to the annotation application, which synchronizes the original file and the annotation file, included in the search result, and combines and outputs to the annotation interface the original file and annotation file.

Also, it has been described for the sake of convenience in this description that the annotation application and the desktop searching application are separately installed and operated. It shall be evident, however, to anyone skilled in the art that one integrated application can perform the above-described processes.

In accordance with another embodiment of the present invention, an annotation file can be generated for a file that is created by a user on a web and uploaded to the web server 102. The web server 102 can receive a search keyword from the user and search the original file or the annotation file.

In case the user selects a created file and request the generation of an annotation file on the web, the web server 102 in accordance with a second embodiment of the present invention transmits a webpage for inputting annotation details and carries out the steps of generating an annotation file after receiving the annotation details inputted by the user.

Then, in case that the web server 102 receives a search keyword from the user, the web server 102 can search for the original file or annotation file corresponding to the search keyword and provide the combination of the original file and annotation file to the user.

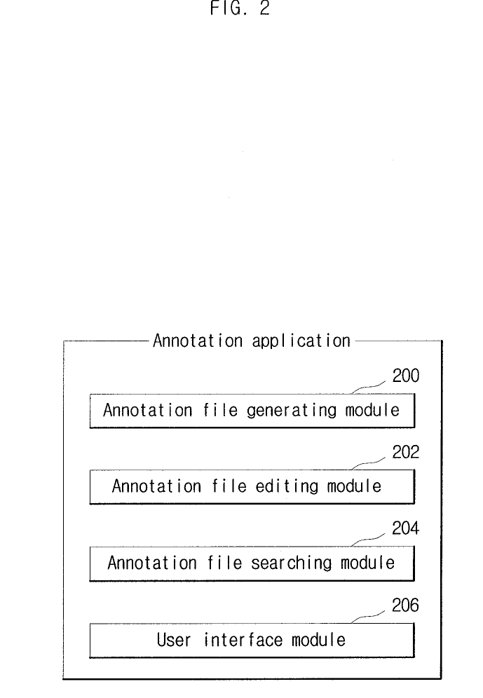

FIG. 2 illustrates a module structure of the annotation application in accordance with the first embodiment of the present invention.

As illustrated in FIG. 2, the annotation application in accordance with the present invention can include an annotation file generating module 200, an annotation file editing module 202, a file outputting module 204 and a user interface module 206.

The annotation file generating module 200 generates an annotation file in accordance with annotation details inputted by the user.

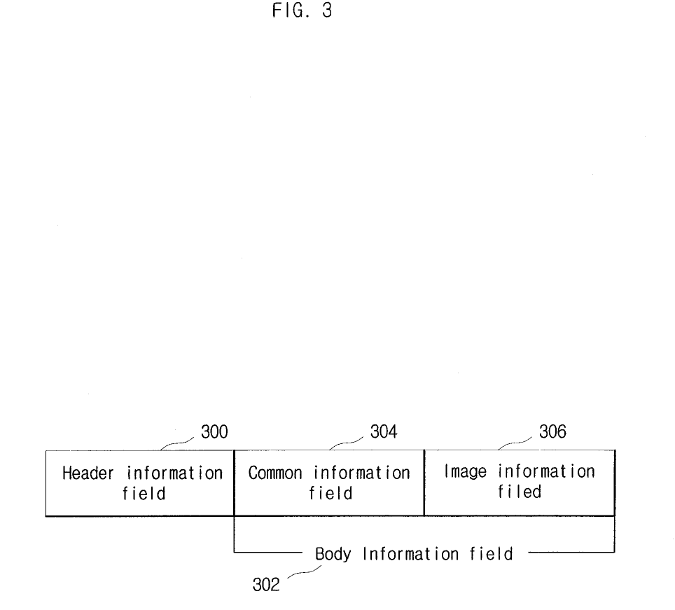

In case that the user inputs the annotation details into the annotation interface, the annotation file generating module 200 generates an annotation file having the annotation details. The annotation file in accordance with the present invention is defined with an extensible markup language (XML) as illustrated in FIG. 3 and the file structure described below. The annotation file includes a header information field 300 and a body information field 302. The body information filed 302 can have a common information field 304 and an image information filed 306.

<?xml version=“1.0” ?>
<Annotation>
<AnnHeader>

<Version>1.0.0.1</Version>

<CreateTime>2005-11-15 15:48:50</CreateTime>
<CreateUser>Administrator</CreateUser>
<ModifyTime>2005-11-15 16:06:15</ModifyTime>
<OrgFileName>C:\ANNOTATION_TESTHAN.DOC</OrgFileName>
</AnnHeader>
<AnnBody>

<Title>Family picture</Title>

<Subject>JungAng park family picture</Subject>
<Category>Family</Category>
<Sticker>NBR_RED_POINT</Sticker>
<Keyword>JungAng park, family, fall, picnic </Keyword>
<Description>Fall picnic picture in JungAng park</Description>
<Location>In JungAng park </Location>
<People>HuSun, Jang CheolSu, Jang GillDong</People>
<Object>summer house in the background </Object>
<Feeling> bright and clear day</Feeling>
<Camera>Nickon&#x0A;Coolpix&#x0A;2300</Camera>
</AnnBody>
</Annotation>

The header information field 300 can have version information (Version) of the annotation file, a date of generating the annotation file (CreateTime), a window ID for generating the annotation file (CreateUser), a date of modifying the annotation file (ModifyTime) and a name of the original file linked to the annotation file (OrgFileName).

The annotation details inputted by the user can be written in the body information field 302. For every file, the common information field 304 of the body information field 302 can include the original file title (Title), the original file subject (Subject), the original file category (Category), the original file importance recognition information (Sticker), the original file keyword (Keyword) and the original file description (Description).

In case that the original file is an image file, the image information field 306 can be included in the body information field 302 and have a photographed place (Location), a photographed person (People) and a photographed object (Object) of an image file and a photographing feeling (Feeling) and a photographing camera (Camera).

The above-described information stored in each field has been described as an example. It is well-known to anyone skilled in the art that other information can be further included in the fields.

It is preferable that the name of the annotation file include the name of the original file such that the user can identify the corresponding original file with the description in the annotation file.

For example, in case that the original file is displayed by a format of “original-file-name.extension” in a particular folder, the annotation file name can be “original-file-name.extension.ANN.” Here, ANN is an extension to show that this file is an annotation file.

Accordingly, in case that the user checks a folder where the annotation file is stored, the user can easily recognize which original file is corresponding to each annotation file.

If the user modifies or deletes the annotation details of the previously generated annotation file, the annotation file editing module 202 applies the modification or deletion to edit the annotation file.

If the user inputs a search keyword into a predetermined area of the annotation interface to search the original file or the annotation file, the file outputting module 204 outputs the original file or the annotation file corresponding to the search keyword among the original or annotation files stored in the user terminal 100.

In the present invention, the searching of the original file or the annotation file can be performed by the operating system installed in the user terminal. Alternatively, the annotation application itself can search the original file or the annotation file.

However, the way the original file or annotation file is searched is not limited to what is described above. Alternatively, the desktop searching application can perform this function. In this case, the annotation application can receive the search result from the desktop searching application and output the combination of the original file and the annotation file that are included in the search result.

It shall be evident to those who are skilled in the art that other various methods for the searching process can be performed.

The user conventionally searches the original file by using the original file name or the folder where the original file is stored. In accordance with the present invention, however, the user can sort the original files with use of various annotation details about the original files and easily organize/search the files by searching the files with the use of the description included in the annotation details.

The user interface module 206 transfers user request to the above-described modules. In accordance with an embodiment of the present invention, the user interface module 206 can output the annotation interface according to the user request.

As illustrated in FIG. 8 and described above, the annotation interface can be used for generating the annotation, inputting the search keyword of the annotation file or original file and checking the search result.

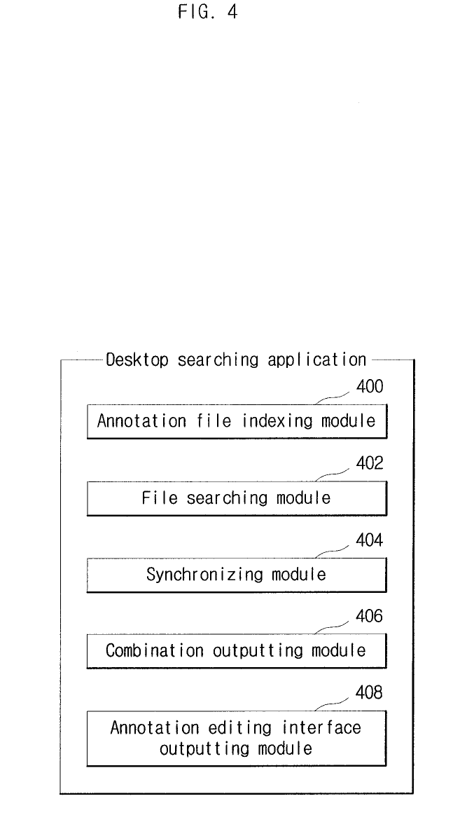

FIG. 4 illustrates a module structure of the desktop searching application in accordance with the first embodiment of the present invention. The desktop searching application in accordance with the present invention can include an annotation file indexing module 400, a file searching module 402, a synchronizing module 404, a combination outputting module 406 and an annotation editing interface outputting module 408.

In case that the user generates the annotation file through the annotation application, the annotation file indexing module 400 in accordance with the present invention performs the steps of indexing the annotation file by recognizing the generation of the annotation file.

Through the indexing of the annotation file, the searching of the annotation file becomes much easier.

If the user inputs the search keyword for searching the original file or annotation file, the searching module 402 receives this search keyword and searches the original file or the annotation file corresponding to the search keyword. Then, the searching module 402 synchronizes the original file and the matched annotation file.

In case that the user inputs a search keyword in the search window of the web browser, the combination outputting module 406 outputs the combination of the original file and annotation file in a webpage format, as shown in FIG. 10, to the web browser.

There can be an annotation editing interface area in an outputted search result page of the web browser. If the user requests to edit the annotation details in the search result page, the annotation editing interface outputting module 408 outputs an annotation editing interface, as illustrated in FIG. 10.

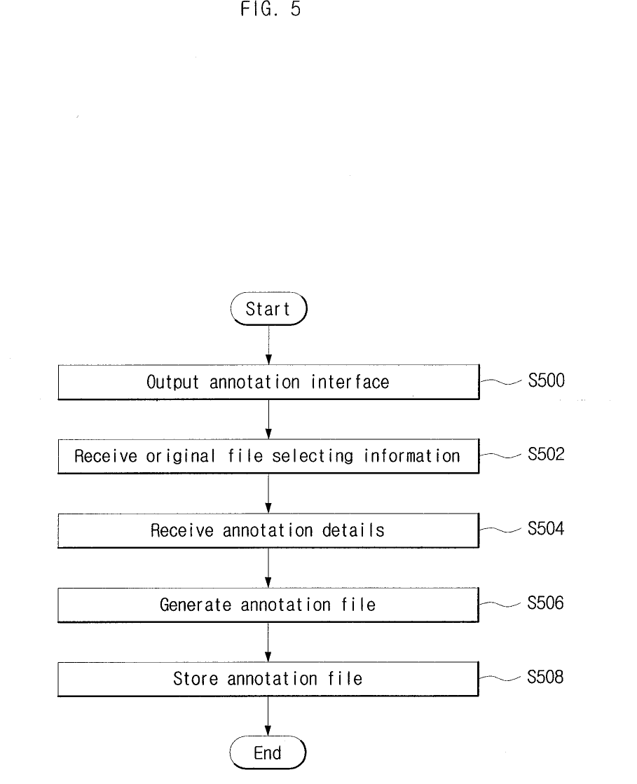

FIG. 5 is a flow chart illustrating a process of generating the annotation file in accordance with the first embodiment of the present invention.

Referring to FIG. 5, in the case of a request by the user, the annotation application outputs the annotation interface in a step represented by S500 and receives original file selecting information in a step represented by S502.

The annotation application receives the annotation details on the original file selected by the user in a step represented by S504 and generates the annotation file having header information and body information corresponding to the annotation details in a step represented by S506.

If the original file selected by the user is an image file, an area for inputting annotation details on the image is additionally provided in the annotation interface. In case that the user inputs the annotation details on the image, an annotation file having the body information added with the image information is generated.

It is preferable that the generated annotation file has an annotation file name corresponding to the original file name and is matched to the original file and stored.

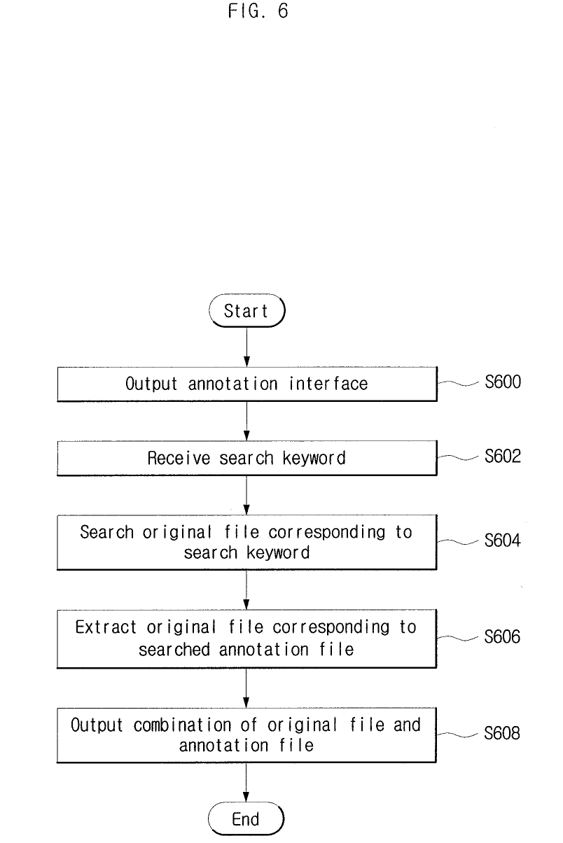

FIG. 6 is a flow chart illustrating a process of searching the annotation file in accordance with the first embodiment of the present invention. FIG. 6 illustrates a process of searching the original file or the annotation file through the annotation interface of FIG. 8.

Referring to FIG. 6, in case that the user requests to search the original file, the annotation application outputs the annotation interface in a step represented by S600 and receive the search keyword inputted by the user in a step represented by S602.

The annotation application searches the original file or the annotation file corresponding to the search keyword in a step represented by S604. In case that the searched file is the original file, the matched annotation file is extracted, and in case that the annotation file is searched, the matched original file is extracted, in a step represented by S606.

The annotation application outputs the combination of the extracted original file and annotation file.

Accordingly, the user can check the original file along with the corresponding annotation file.

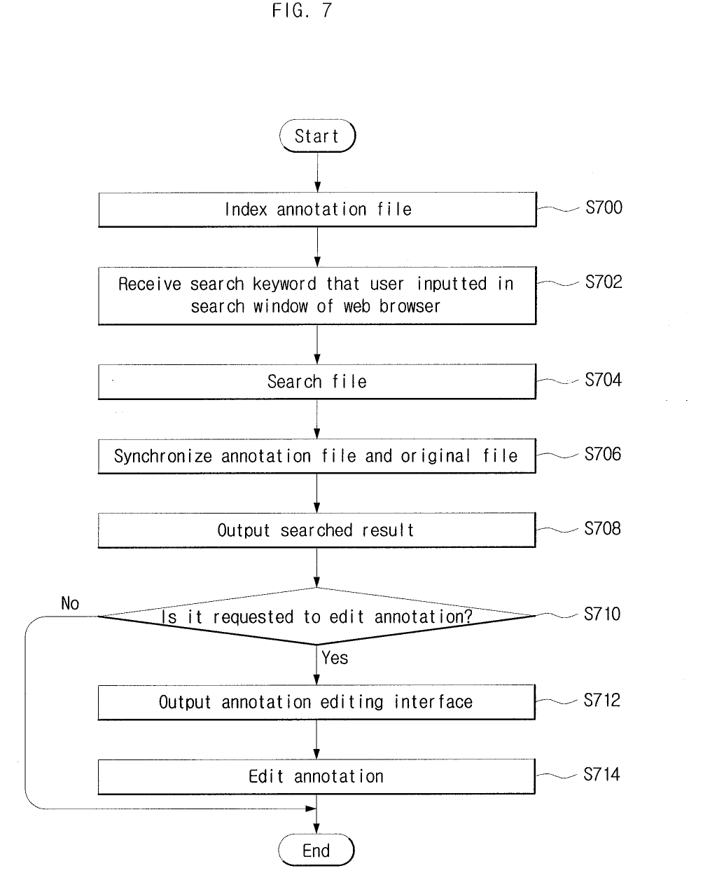

This searching of the original file can be performed by the desktop searching application in accordance with the present invention. FIG. 7 is a flow chart illustrating a process of searching files by linking the desktop searching application in accordance with the present invention.

Referring to FIG. 7, the desktop searching application indexes the annotation file in a step represented by S700, in case that the annotation file is generated.

Then, the desktop searching application receives the search keyword that the user inputted in the search window of the web browser.

When receiving the search keyword, the desktop searching application searches the original file or the annotation file corresponding to the search keyword in a step represented by S704.

Accordingly, the searching of the annotation file and the original file matched to the annotation file can be easily performed by the indexing of the annotation file when the annotation file is generated.

When the files are searched, the desktop searching application synchronizes the annotation file and the original file in a step represented by S706 and outputs the combination of the synchronized original file and annotation file in a webpage format to the web browser in a step represented by S708.

In accordance with the present invention, the annotation can be edited through the search result page displayed in the web browser window. The desktop searching application determines whether the user requested to edit the annotation in a step represented by S710. In case that the editing of the annotation is requested, as illustrated in FIG. 10, the desktop searching application outputs an annotation editing interface in a step represented by S712 and edits the annotation in accordance with the user inputted information in a step represented by S714.

Hitherto, it has been described that the annotation application installed in the user terminal generates the annotation file, and the files are searched by using the annotation application or the desktop searching application. In accordance with the second embodiment of the present invention, however, the annotation file can be generated for the files created in the web by the user, and the searching of the annotation file can be performed with use of the generated annotation file.

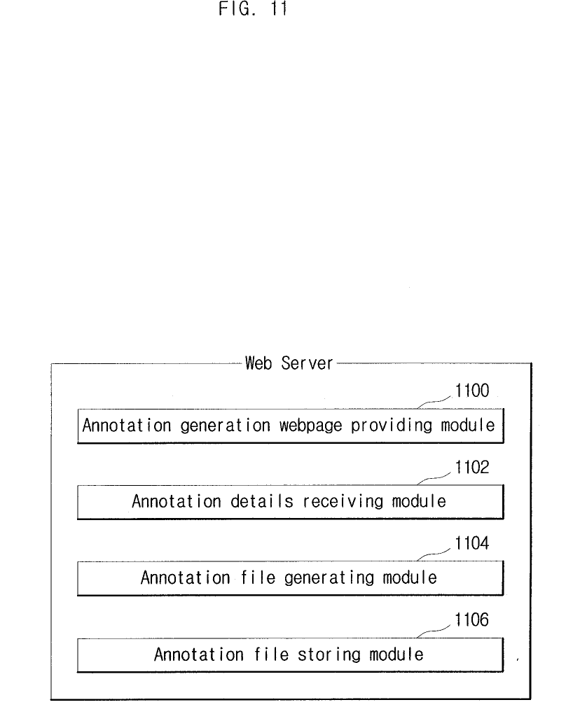

FIG. 11 illustrates a module structure of the web server in accordance with the second embodiment of the present invention. As illustrated in FIG. 11, the web server in accordance with the present invention can have an annotation generation webpage providing module 1100, an annotation details receiving module 1102, an annotation file generating module 1104 and an annotation file storing module 1106.

In accordance with the second embodiment of the present invention, it is not necessary that the user terminal is installed with an additional application. While accessing the web server, the user can generate an annotation file and receive the result searched by using the annotation file, through the webpage.

If the user selects the file created by the user in the web and requests to generate the corresponding annotation file, the annotation generation webpage providing module 1100 provides to the user terminal 100 the webpage having an area capable of being inputted with the annotation details.

In case that the user inputs the annotation details in the webpage, the annotation details receiving module 1102 receives the annotation details from the user terminal, and the annotation file generating module 1104 generates the annotation file having the header information and the body information corresponding to the annotation details.

Since the header information and the body information have been described above in detail, the redundant description thereof will be omitted.

The annotation file storing module 1106 matches and stores the generated annotation file and the original file selected by the user.

Through this matching and storing process, when searching the original file or the annotation file, the combination of the original file and the annotation file can be provided to the user.

Since the web server 102 supports the generating and searching functions of the annotation file, the user can generate annotation files for all files created on the web and efficiently search the original file by using the generated annotation file.

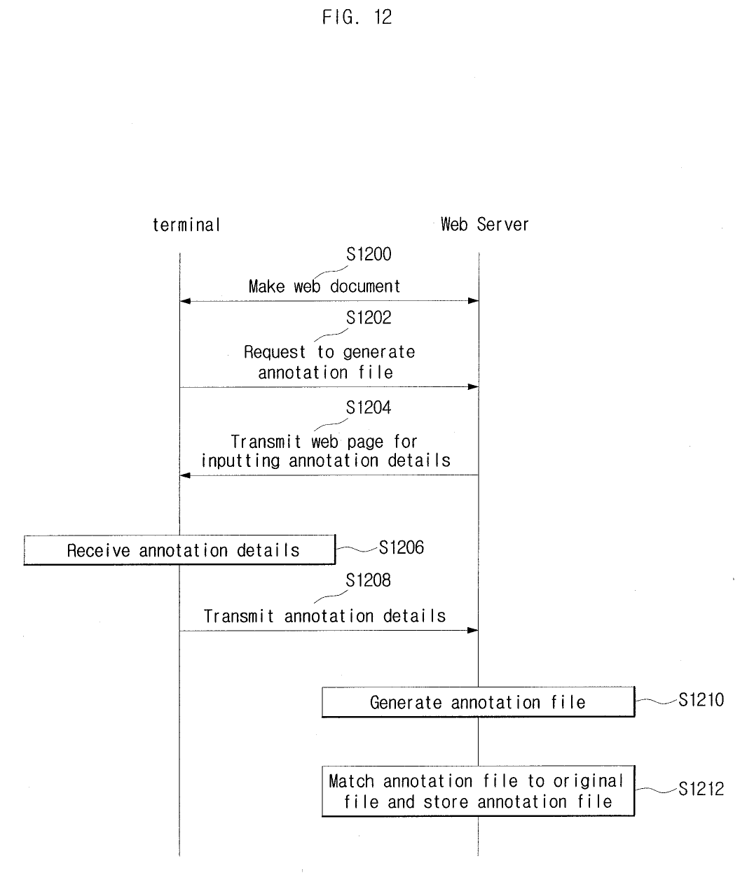

FIG. 12 is a flow chart illustrating a process of generating the annotation file in accordance with the second embodiment of the present invention.

FIG. 12 assumes that the annotation file is generated for a web document created by the user. Referring to FIG. 12, the user accesses the web server 102 to make the web document in a step represented by S1200. If the user desires to generate an annotation file for the created web document, the user terminal 100 requests the web server 102 to generate the annotation file in a step represented by 1202.

In response to the request by the user terminal 100, the web server 102 transmits to the user terminal the web page for inputting the annotation details in a step by S1204.

In case that the user inputs the annotation details into the web page, the user terminal 100 receives the annotation details in a step represented by S1206 and sends the annotation details to the web server 102 in a step represented by S1208.

The web server 102 generates the annotation file having the header information and the body information corresponding to the annotation details in a step represented by S1210 and matches to the original file and stores the annotation file.

Like this, if the annotation file for the original file is generated, in case that the user later inputs the search keyword, the web server (or a separate searching server) can provide the search result of the original file corresponding to the search keyword and the annotation file matching the original file (or the annotation file and the original file matching the annotation file) to the user.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, the present invention can efficiently sort the files by generating annotation information on the original files stored in a user terminal.

With the present invention, the user can easily change the structure of annotation files because the annotation files are defined with an extensible markup language (XML).

The present invention can easily search the original files by using annotation detailed information.

In addition, the present invention can provide convenience to the user by allowing the user to generate the annotation files through a web server, search the original files and edit the annotation files in a page provided by the web server.

1-16. (canceled)

17. A method of sorting and searching files, comprising the steps of:
(a) enabling a user to create or edit an annotation associated with a first electronic file by using a user interface;
(b) receiving annotation data from the user through the user interface, the annotation data comprising at least one selected from the group consisting of a title, a subject, a category, an importance, a keyword and a description of the first electronic file;
(c) generating an annotation file associated with the electronic file based on the annotation data, the annotation file comprising attribute data of the annotation file and at least a portion of the annotation data associated with the first electronic file; and
(d) storing the annotation file.

18. The method of claim 17, wherein the annotation file is defined with an extensible markup language (XML).

19. The method of claim 17, further comprising the step of creating a file name of the annotation file, the file name of the annotation file including a name of the first electronic file.

20. The method of claim 17, wherein the annotation file comprising a header information field and a body information field, the header information field including at least one of a name of the first electronic file and a date of generating the annotation file, the body information field including the at least a portion of the annotation data associated with the first electronic file.

21. The method of claim 20, wherein the body information field comprises an image information field having at least one of a photographed place, a photographed person, a photographed object and a photographing camera of an image file.

22. The method of claim 17, wherein the annotation file is linked to the first electronic file.

23. The method of claim 17, further comprising the steps of:
receiving a search request including a search keyword from the user;
in response to the user's request, searching for a second file corresponding to the search keyword, the second file being stored in a storage medium;
searching for a third file associated with the searched second file; and
providing search result, the search result including both the second file and the third file,
wherein the second file is any one of the first electronic file and the annotation file, and the third file is the other of the first electronic file and the annotation file.

24. The method of claim 23, further comprising:
indexing the generated annotation file; and
synchronizing the searched annotation file to the first electronic file.

25. The method of claim 17, wherein the steps of (a) through (d) are performed by a web server that is connected to a user terminal through a network, and the original file is a web file created by a user on the web.

26. The method of claim 17, wherein the steps of (a) through (d) are performed by an application that is installed in the user terminal, and the first electronic file is stored in the user terminal.

27. A method of sorting and searching files comprising:
(a) receiving a search request including a search keyword from a user;
(b) in response to the user's request, searching for a first file corresponding to the search keyword, the first file being stored in a storage medium;
(c) searching for a second file associated with the searched first file; and
(d) providing search result, the search result including both the first file and the second file.

28. The method of claim 27, wherein the first file being at least one of an original file and an annotation file associated with the original file, the annotation file including at least a portion of annotation data inputted by a user for the original file.

29. The method of claim 28, wherein the annotation data comprise attribute data of the annotation file and at least a portion of the annotation data associated with the first electronic file.

30. The method of claim 28, wherein the annotation data comprise a header information field and a body information field, the header information field including at least one of a name of the original file and a date of generating the annotation file, the body information field including the at least a portion of the annotation data associated with the original file.

31. The method of claim 30, wherein the body information field comprises an image information field having at least one of a photographed place, a photographed person, a photographed object and a photographing camera of an image file.

32. The method of claim 29, wherein the annotation file is defined with an extensible markup language (XML).

33. One or more computer-readable media having stored thereon a computer program that, when executed by one or more processors, causes the one or more processors to perform acts including:
enabling a user to create or edit an annotation associated with a first electronic file by using a user interface;
receiving annotation data from the user through the user interface, the annotation data comprising at least one selected from the group consisting of a title, a subject, a category, an importance, a keyword and a description of the first electronic file;
generating an annotation file associated with the electronic file based on the annotation data, the annotation file comprising attribute data of the annotation file and at least a portion of the annotation data associated with the first electronic file;
storing the annotation file;
receiving a search request including a search keyword from the user;
in response to the user's request, searching for a second file corresponding to the search keyword, the second file being stored in a storage medium;
searching for a third file associated with the searched second file; and
providing search result, the search result including both the second file and the third file,
wherein the second file is any one of the first electronic file and the annotation file, and the third file is the other of the first electronic file and the annotation file.

34. A server system connected to a user terminal over a network for supporting sorting and searching files, the system comprising:
a webpage providing module configured to provide a user interface for receiving annotation data associated with original files from a user terminal;
an annotation data receiving module configured to receive over a network the annotation data from the user terminal through the user interface, the annotation data comprising at least one selected from the group consisting of a title, a subject, a category, an importance, a keyword and a description of the original files;
an annotation file generating module configured to generate an annotation file based, at least in part, upon the annotation data, the annotation file comprising attribute data of the annotation file and at least a portion of the annotation data associated with the original file; and
an annotation file storing module for associating the annotation file with the original file and storing the annotation file.
